(19) United States
(12) Patent Application Publication
(10) Pub. No.: US 2019/0109824 A1
(43) Pub. Date: Apr. 11, 2019

(54) RULE ENFORCEMENT IN A NETWORK

(71) Applicant: FIRMITAS CYBER SOLUTIONS (ISRAEL) LTD., Kfar Saba (IL)

(72) Inventors: Gil KEINI, Nirit (IL); Rami SHAFT, Rehovot (IL)

(73) Assignee: FIRMITAS CYBER SOLUTIONS (ISRAEL) LTD., Kfar Saba (IL)

(21) Appl. No.: 16/087,839

(22) PCT Filed: Mar. 21, 2017
(86) PCT No.: PCT/IL2017/050352

§ 371 Date: Sep. 24, 2018

Related U.S. Application Data
(60) Provisional application No. 62/311,943, filed on Mar. 23, 2016.

(51) Int. Cl. H04L 29/06; H04L 12/24

(52) U.S. Cl. CPC H04L 63/0263; H04L 63/306; H04L 41/22; H04L 63/1441; H04L 63/20; H04L 63/1408

(57) ABSTRACT

A method, apparatus and computer program product, the computer program product comprising a computer readable storage medium retaining program instructions, which program instructions when read by a processor, cause the processor to perform: intercepting a sequence of messages comprising one or more outgoing messages of a first type transmitted by a first appliance within a network, one of the outgoing messages being directed to a second appliance, wherein the second appliance is allowed to receive messages of the first type in accordance with a collection of enforcement rules, wherein the outgoing message comprises one or more fields having a value, wherein the collection of enforcement rules is associated with the network; validating the outgoing message against the collection of enforcement rules; and in response to the outgoing message not complying with a rule from the collection of enforcement rules, screening the outgoing message, thereby protecting a second appliance from receiving the outgoing message.

### CROSS-REFERENCE TO RELATED APPLICATION

This application claims the benefit of U.S. Provisional Application No. 62/311,943 filed Mar. 23, 2016, entitled “Systems and Methods for Protocol Enforcement and Cyber Security”, which is hereby incorporated by reference in its entirety.

### TECHNICAL FIELD

The present disclosure relates to enforcing rules in networks in general, and to protecting devices from harmful or disruptive messages, in particular.

### BACKGROUND

Computerized devices and systems control almost every aspect of our life, especially in industry. In order to provide the required services or supply, modern factories, utility providers and other sites need and use tens to tens of thousands of computerized devices, connected in one or more networks.

Each such device may be regarded as a Computer Based Appliance, also referred to as a device or as an appliance, having processor such as a CPU and one or more communication interfaces. Some devices comprise controllers for controlling machines such as engines, turbines, or the like. In some situations, the networks may also comprise one or more virtual appliances, being an operating system or application environment installed as software, which imitates the behavior of dedicated hardware, and possibly additional components. Any device within the network may be configured for receiving and/or transmitting communication, for example to or from other devices either within the network or external to it.

The devices within the network may communicate using any common or proprietary communication protocol, in which messages are transmitted over some communication infrastructure. The messages may include commands, instructions, data, or the like. Some of the devices may have connection to computing platforms external to the network, such as an Internet connection, while others may communicate only with devices from within the network.

The connectivity between the devices, while allowing control and productivity, also exposes all devices within a network, and not only the ones connected to the outer world, to risks such as viruses, Trojan horses, bugs, malicious actions by internal or external agents, and others. Some risks may originate from the outer world and spread within the network by the devices connected thereto, while other risks may originate from devices within the network. Any such device may transmit disruptive messages to other devices, by mistake, by accident or due to malicious activity of a legitimate user or an attacker.

A device which is of particular importance may be referred to as a target system, target appliance or simply target, and thus needs to be specifically protected in order to avoid significant damage to people or property, or other problems such as system down time. Some examples include crucial servers, controllers controlling system components such as centrifuges, turbines, pumps or other utility-providing machines, airplane critical components, traffic light controllers, or the like.

### BRIEF SUMMARY

One exemplary embodiment of the disclosed subject matter is a computer program product comprising a computer readable storage medium retaining program instructions, which program instructions when read by a processor, cause the processor to perform a method comprising: intercepting a sequence of messages comprising one or more outgoing messages of a first type transmitted by a first appliance within a network, one outgoing message being directed to a second appliance, wherein the second appliance is allowed to receive messages of the first type in accordance with a collection of enforcement rules, wherein the outgoing message comprising one or more fields having a value, wherein the collection of enforcement rules is associated with the network; validating the outgoing message against the collection of enforcement rules; and in response to the outgoing message not complying with the collection of enforcement rules, screening the outgoing message, thereby protecting a second appliance from receiving the outgoing message. Within the computer program product, said validation optionally comprises comparing the value of a field to one or more values of a field of an enforcement rule of the collection of enforcement rules. Within the computer program product, a rule of the collection of enforcement rules optionally enables transmission of messages of the first type only in response to a source of the one outgoing message being included in a collection of predetermined sources, and wherein said validation comprises verifying that the first appliance is included in the collection of predetermined sources. Within the computer program product, a rule of the collection of enforcement rules optionally enables transmission of messages of the first type by the first appliance only within a predetermined time range, and wherein said validation comprises verifying that the outgoing message is sent at a time within the predetermined time range. Within the computer program product, a rule of the collection of enforcement rules optionally enables transmission of messages of the first type by the first appliance only if the value is within a predetermined value range, and wherein said validation comprises verifying that the value is within the predetermined value range. Within the computer program product, a rule of the collection of enforcement rules enables transmission of messages of the first type by the first appliance only when the second appliance is at a predetermined state, and wherein said validation comprises verifying that the at least one second appliance is at the predetermined state at a transmission time of the at least one outgoing message. Within the computer program product, a rule of the collection of enforcement rules optionally enables transmission of messages of the first type by the first appliance only in response to a relative order kept between the outgoing message and a second message, and wherein said validating comprises verifying that the relative order is kept between the outgoing message and the second message. Within the computer program product, validating optionally comprises checking whether a structure of the outgoing message is in compliance with the collection of enforcement rules. Within the computer program product, the processor optionally further notifies a user responsive to the outgoing message not complying with the collection.

Another exemplary embodiment of the disclosed subject matter is a computer-implemented method, comprising: intercepting a sequence of messages comprising one or more outgoing messages of a first type transmitted by a first appliance within a network, one outgoing message being directed to a second appliance, wherein the second appliance is allowed to receive messages of the first type in accordance with a collection of enforcement rules, wherein the outgoing message comprising one or more fields having a value, wherein the collection of enforcement rules is associated with the network; validating the outgoing message against a collection of enforcement rules, said validating comprising relating to the value; and in response to the outgoing message not complying with the collection of enforcement rules, screening the at least one outgoing message, thereby protecting the second appliance from receiving the outgoing message.

Yet another exemplary embodiment of the disclosed subject matter is a computerized apparatus having a processor and network communication capabilities, the processor being adapted to perform the steps of: intercepting a sequence of messages comprising one or more outgoing messages of a first type transmitted by a first appliance, one outgoing message being directed to a second appliance, wherein the second appliance is allowed to receive messages of the first type in accordance with a collection of enforcement rules, wherein the at least one outgoing message comprising one or more fields having values, wherein the collection of enforcement rules is associated with the network; validating the outgoing message against a collection of enforcement rules; and in response to the outgoing message not complying with the collection of enforcement rules, screening the outgoing message, thereby protecting the second appliance from receiving the outgoing message. The computerized apparatus, is optionally implemented within the first appliance or within the network between the first appliance and any other network device. Within the computerized apparatus, the steps are optionally implemented as software instructions executed by the first appliance.

Yet another exemplary embodiment of the disclosed subject matter is a computer program product comprising a computer readable storage medium retaining program instructions, which program instructions when read by a processor, cause the processor to perform a method comprising: display and activate a user interface, with which a user can define one or more enforcement rules, each enforcement rules comprising allowed rule fields and rule values for outgoing messages to be transmitted by a first appliance; receiving from the user a definition of the enforcement rules; and generating computer code for: intercepting a sequence of messages comprising one or more outgoing messages of a first type transmitted by a first appliance within a network, an outgoing message being directed to a second appliance, wherein the second appliance is allowed to receive messages of the first type in accordance with a collection comprising the at least one enforcement rule, the outgoing message comprising one or more fields having values; validating the outgoing message against the collection comprising the said validating comprising relating to the value; and in response to the outgoing message not complying with the collection of enforcement rules, screening the outgoing message.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic block diagram of a system for screening outgoing messages, in accordance with some embodiments of the disclosure;

FIG. 2 is a schematic block diagram of an exemplary network configuration in which some messages may be allowed to be transmitted to a target device by one device but not by another;

FIGS. 3A-3C are schematic block diagrams of embodiments of locating rule enforcement module relative to source device, in accordance with some exemplary embodiments of the disclosed subject matter;

FIG. 4 is flowchart of steps in a screening method, in accordance with some exemplary embodiments of the disclosed subject matter; and

FIG. 5 is a flowchart of steps in a method for creating a rule enforcement module, in accordance with some exemplary embodiments of the disclosed subject matter.

### DETAILED DESCRIPTION

One technical problem dealt with by the disclosed subject matter is the need to protect devices within a network from receiving problematic messages which may cause significant damage to people, to the device itself, to a system controlled by the device, or to other devices within the network or elsewhere.

Traditional methods include the screening of the communication incoming into a device, in order to ensure that no problematic message is received and processed or acted upon. However, this technique does not always provide sufficient protection.

In some cases, a device may be allowed to receive and act upon a received message, instructing it for example to reboot itself. However, such message is legitimate only if received from an authorized device, such as a controller. If such message is received from a printer, for example, there is significant probability that the message is a result of an attack on the network or on the specific device, whether the attack is from within the network or from the outside, for example a Trojan horse attack. Alternatively, the message may be a result of a mistake or a problem with the device that transmitted the message or with another device.

Similar situations may include with messages received at a wrong time, wrong order, or having any other problem, that would otherwise be legitimate. The receiving device may thus attempt to process and act upon the messages, thus creating damage and possibly transmitting problematic messages to further devices.

One technical solution of the disclosed subject matter relates to defining rules to be enforced on messages transmitted by one or more message-transmitting devices in a network. Outgoing messages attempted to be transmitted by the devices can then be intercepted, and the rules may be enforced on the intercepted messages, thus protecting the target devices of the messages. The disclosure thus provides for protecting target devices by other appliances in the network, which screen their own outgoing communications to ensure that outgoing communications are not disruptive of the target devices.

Each message generally comprises fields, wherein one or more values are assigned to each such field. Some of the fields may comprise meta data such as a message type, while others may comprise actual data such as content of the message, for example an engine speed to be assumed. The enforcement rules can define conditions, limitations or requirements on any field or field combination of the outgoing messages which the device is attempting to transmit, or combination of fields belonging to multiple such messages. Some common fields that may be verified as part of validating the message include but are not limited to a recipient device of the message, a message type, message time, recipient status, value of a field being within a predetermined range or the like. The messages may also be validated to screen mal-formed messages, message of incorrect structure, message with incorrect field(s) values, incorrect logic between field values within the same message where the value of one field is related to or depends upon another field, incorrect logic between consecutive messages, incorrect message order, incorrect message type in the context of the specific system state, message history relating for example to a maximal number of message of particular type allowed to be sent every day or criteria relating to the content of the previous messages, such as rate of change of an engine speed setting, or the like. The messages may also be validated to verify correct query-response pairing, or the like.

One technical effect of the disclosure is the prevention of the mere transmission of a forbidden message to a target device. This screening provides improved security and increases the probability that the target device will not receive unwanted or leaked messages or data. Specifically, this screening helps protect a target device against receiving messages that may be legitimate under different circumstances, such as a different transmitter, different time, status or the like.

Screening the outgoing messages can improve protection in a variety of situations, such as but not limited to:

1. Implanted malware, in which rogue firmware or software is implanted on a device in the internal network. For example, a foreign agent pretending to be a technician or an internal human operator may install a virus on a device such as a printer, which may penetrate the target device or make the target device behave in an unintended way and cause damages. By enforcing predetermined rules on the printer and blocking attempts to transmit undesired messages, the malicious implanted functionality is blocked from harming assets on the connected network. Even further, the attack attempt may be noticed by the enforcer module and reported to a person in charge such as a network manager, thus identifying the breach of the printer. Screening outgoing message of devices may also be helpful in situations in which a network appliance is hijacked in a Trojan horse-like manner, thus risking the target device with an attack from within or risking the leaking of confidential data from within the network.

2. A programming bug or another problem of the transmitting device, which may therefore attempt to transmit problematic messages and cause undesired behavior of the target device.

3. Inter-operability issues in which the source device and the target device are manufactured by different manufacturers, or at different times. Since different developers may interpret and/or implement the same communication standard in slightly different ways, inter-operability issues may arise. This may lead to situations in which a message assumed to be correct and legitimate by the transmitter is interpreted in an incorrect manner by the recipient, which may thus behave in an undesired manner.

5. Data leakage: a situation of a device attempting to send data to an external or otherwise illegitimate recipient may also be caused by a device infected by a Trojan horse, or a malware trying to send information. Enforcing rules on the outgoing messages may prevent sending information from within a system to an unauthorized receiver and thus prevent data leakage.

Another technical effect of the disclosure relates to improving the total system up-time. By making sure that target system is not harmed, and further, do not cause harm to further components, the system up-time is improved.

Yet another technical effect of the disclosure relates to not only preventing but also detecting and notifying users about attack attempts, such that preventive measures can be taken. Validating the outgoing messages is effective also after any other protection measure has been taken, such as installing anti-virus or the like.

Yet another technical effect of the disclosure relates to enabling the tracking of the system state, and verifying correlation between transmitted and received messages.

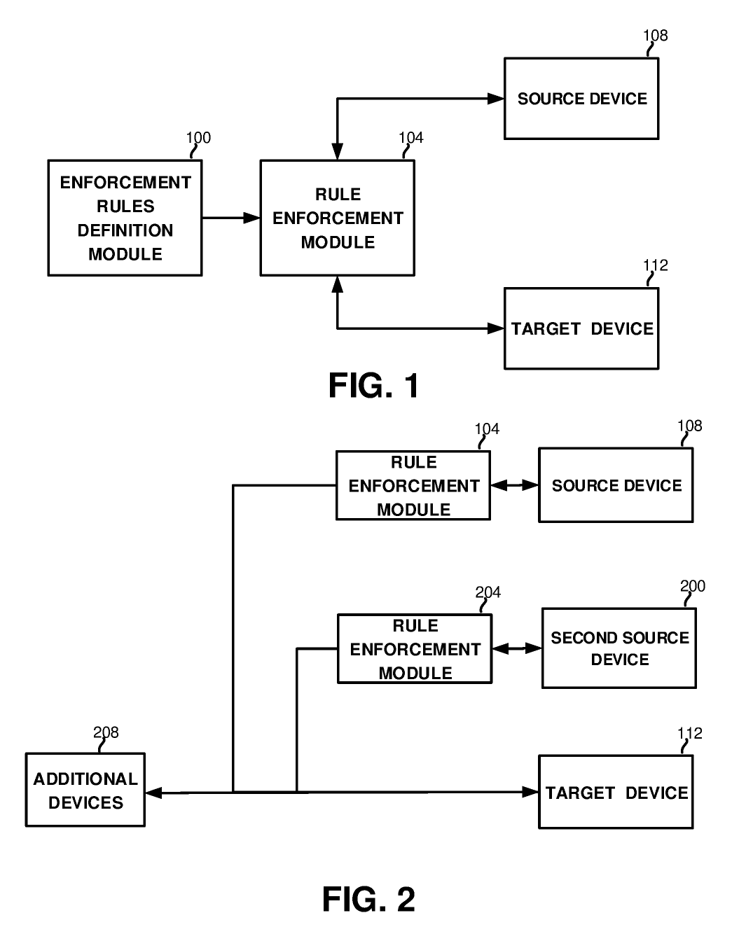

Referring now to FIG. 1, showing a schematic block diagram of a system for screening outgoing messages, in accordance with some embodiments of the disclosure.

The system can comprise enforcement rules definition module 100 for defining a communication model for the network or for an appliance therein and defining rules to be enforced. The system can further comprise rule enforcement module 104 for enforcing the rules on messages outgoing from source device 108 to target device 112.

The communication model may include but is not limited to definitions of one or more communication protocols, transport layer coupling for a specific protocol, source-destination pairing, protocol order, relating for example to a session starting at one protocol over one channel and continuing with a second protocol over a second channel.

As part of the implementation coupling between messages, a state machine can be used for tracking the state of each session within a communication protocol. Some examples include a request/response structure with ID fields identifying the request repeated in the response, and setting a maximal number of messages of a certain type per day, as detailed below. It will be appreciated that state machines may also include non-message events governing flow, such as time outs.

A user can further use enforcement rules definition module 100 for defining rules to be enforced on messages outgoing from one or more devices in a network. Enforcement rules definition module 100 can be implemented as a software module executed by a general-purpose computing platform, as a dedicated computing platform, as an independent process, a library, a virtual machine, or the like. The module can be used as part of constructing or maintaining the network, and may be implemented as part of a system for design and implementation of certain aspects of the system, and in particular security aspects.

In some exemplary embodiments, enforcement rules definition module 100 can be used offline, on a computing platform that may or may not be connected to the network. The resulting definitions can then be imported in to the network and applied. Rules definition module 100 can receive or deduce a description of the network, including the devices and their types, a description of the communication protocol(s) used, or the like. Enforcement rules definition module 100 may comprise a graphic user interface enabling a user to define the enforcement rules. A user may select a device; indicate, for example by selecting from a list, message types which are legitimate for the device to transmit; and optionally provide one or more values for one or more fields within the messages, thus describing certain limitations, such as allowed recipients, allowed transmission time or status, interdependency between fields within the same message or different messages, relating to communication history as additional mechanism for defining rules or the like.

Some non-limiting rule examples include:

1. Messages that may be allowed to be transmitted to a target device by one device but not by another:

Referring now to FIG. 2, showing a schematic block diagram of a network configuration, in which such situation may occur. In the network of FIG. 2, source device 108 may transmit messages of certain types to target device 112. However, such messages when transmitted by another source, such as second source device 200 are illegitimate, and damage may be caused to or by target device 112 if the message sent by second source device 200 is received and handled. Thus, each transmitting device 108, 200 may be associated with a corresponding rule enforcement module 104, 204 respectively. Rule enforcement module 104, 204 can monitor and intercept the messages transmitted by the corresponding source 108, 200, and screen those messages which are illegitimately transmitted by the respective source to target device 112. Thus rule enforcement module 104 may enable the transmission of said message from source device 108 to target device 112, while rule enforcement module 204 may disable the transmission of said message from source device 200 to target device 112. The rules may relate to the type and target fields of the message. In some embodiments, a single rule enforcement module can be used, which monitors all traffic outgoing any device, wherein a message is transmitted to the target only upon validation by the rule enforcement module. It will be appreciated that the system can comprise additional devices 208, within the network or on another network.

2. Messages transmitted out of order or out of sequence. An enforcement rule handling such message may relate, for example, to screen a message for starting an engine prior to the transmission of messages related to ensuring the necessary safety means were taken. Enforcing such rule requires keeping track of a multiplicity of messages and comparing the order and values of various fields, such as engine ID, time stamp, request/response IDs or others.

3. Messages transmitted at a wrong context or state. An enforcement rule for handling such message may be, for example, to screen a message for starting an engine, which is generally a legitimate message, but not when the engine is in maintenance mode. Enforcing such rule requires the transmitting device to have access to information related to the state of the target device. In some embodiments, the rules may relate to the state of the device whose output is monitored, for example by also monitoring traffic incoming to the device, such as source device 108. In this case, messages outgoing a device are allowed or blocked depending, optionally along other things, on messages incoming into the device.

4. Mal-formed messages, such as legitimate messages which may be corrupted due, for example, to a bug in the transmitting device, which makes the message unreadable by the target device. Enforcing such rule requires parsing multiple fields of the message.

5. Message having incorrect values: for example, speed values in a message to increase or decrease engine speed may be limited to a certain range. The value of the relevant field on the message can be compared to the allowed range, and if the value is not within the range, the message may be screened and not transmitted by the device.

6. Message with incorrect dependency on another message: for example, a client device may address a server with a query, and attach a request ID. When the server replies, if the ID indicated in the response is wrong, the message may be screened and is not transmitted by the server. It will be appreciated that other relations or dependencies between messages may be required to exist in order for a message tone allowed.

Once the rules are defined, they may be adapted to be used by rule enforcement module 104 as disclosed in association with FIG. 5 below.

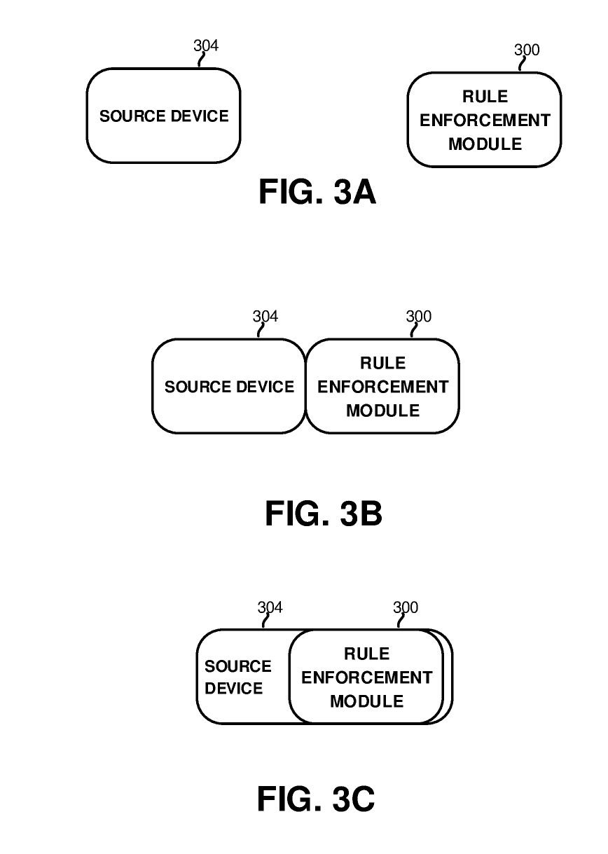

Referring now to FIGS. 3A-3C, demonstrating some exemplary embodiments for deployment of a system in accordance with the disclosure.

FIG. 3A shows a block diagram of an embodiment in which rule enforcement module 300 is not part of any source device 304 in the system but is rather an independent unit intercepting messages transmitted by a multiplicity if devices. Rule enforcement module 300 can be implemented, for example, as a server to which all messages arrive for dispatching, and which can thus stop the dispatching of offending messages. A server in accordance with this configuration may have easier access to information related to different components of the network and may thus be particularly suitable for systems having a multiplicity of rules involving information of the target device or to other conditions in the network.

FIG. 3B shows a block diagram of an embodiment in which rule enforcement module 300 is an independent dedicated software or hardware device situated between source device 304 and any other device in the system, such that it can intercept messages transmitted by source device 304 to any target device.

FIG. 3C shows a block diagram of an embodiment in which rule enforcement module 300 is implemented as part of source device 304. It will be appreciated that this embodiment may refer to rule enforcement module 300 being implemented independently of the main functionality of source device 304 such as an add-on software module executed by a processor of source device 304, or embedded within and performed as part of said functionality.

The embodiments of FIG. 3B and FIG. 3C may be particularly suitable for network in which the messages do not involve information related to the target device or to other conditions in the network.

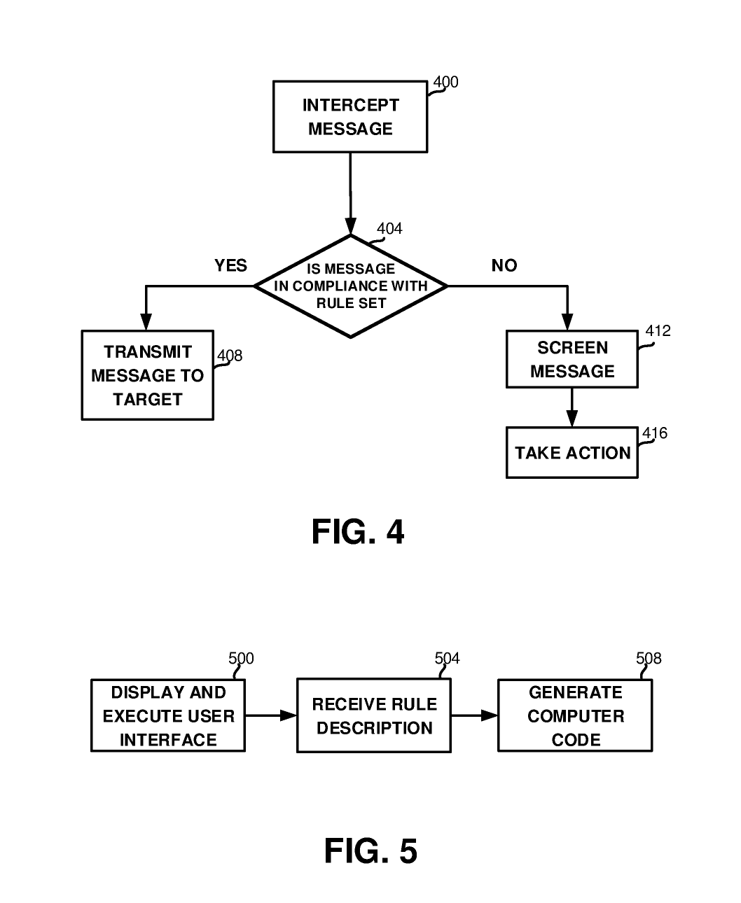

Referring now to FIG. 4, showing a flowchart of steps in a screening method in accordance with the disclosure.

The method may be performed by rule enforcement module 104 of FIG. 1.

On step 400, rule enforcement module 104 can intercept a message in communication transmitted by a source device.

On step 404, rule enforcement module 104 can validate the message against a collection or set of rules. Validation may rely on the specific implementation selected: if the rules are restrictive, i.e., indicate under which conditions the message is allowed to be transmitted, then all rules in a rule collection need to be checked and the message has to comply with all rules in the collection. If the rules are restrictive, i.e. indicate situations in which the message is not allowed to be transmitted to its destination, then once a message is found to be incompliant with a rule from the rule collection, checking the other rules may be omitted, although such checking may still be performed in order to gather as much information as possible. It will be appreciated by a person of ordinary skill in the art that a collection of rules can be equivalently phrased in permissive (in which case all rules re to be checked) or restrictive (wherein if the message is incompliant with one rule is sufficient for not transmitting it) forms, meaning that any collection of rules can be phrased in either form. The specific implementation can be selected upon considerations such as time and space complexity, phrasing ease, or others. In some embodiments, permissive rules may be defined such that compliance with a specific rule makes the checking of other rules unnecessary.

Thus, on step 404 it is determined whether the message is in compliance with at least one rule defined by a user, wherein if the rules are permissive, the message may need to be checked against additional rules, such as the full selection. Determination can depend on other aspects of the specific implementation: if rule enforcement module 104 is common to all transmitting devices, it may need to retrieve identifying information regarding the device transmitting the specific message, and then validate the message against rules applicable to the device. If rule enforcement module 104 is associated with 20 1 a specific source device, then retrieving the device is not required. In some situations, rule enforcement module 104 may need to obtain data from additional sources in order to determine whether the message is in compliance with a rule, for example query about a state of the target device, check previous messages, or the like.

If the message is in compliance with the rule set, as detailed above, the message may be transmitted to the target on step 408. It will be appreciated that even after a rule with which the message is compliant has been determined, further rules may be validated in order to collect as much information as possible. A user may be notified, for example by adding a record to a database or a file, regarding the rule with which the message was compliant.

Otherwise, if the message is incompliant with the rule set, the message is screened on step 412, such that it does not reach the target device. On step 416, one or more actions may be taken, such as notifying a user of the system of the non-compliance, for example an administrator or another person in charge. For example, a notification comprising the message details and the uncomplied rule(s) may be provided to the user or to another computer, e.g. a Network Information Center, which can aggregate security messages. The notification may be provided as a text message, an e-mail, or the like. Some devices may be specifically associated with a notification method for incompliant messages, for example starting an alarm, which may be used in case of non-compliance which can cause severe damage. In some embodiments, after a non-complying message has been intercepted, all further messages by the same source device or even within the whole network may be stopped until the situation is cleared. In other embodiments, further messages may be validated, and transmitted if in compliance with the rules. Other actions may include but are not limited to correcting a message and transmitting the corrected message forward, stopping a message and synthesizing one or two new messages to be transmitted to the source and/or target, or the like.

Referring now to FIG. 5, showing a flowchart of steps in a method for creating a rule enforcement module in accordance with the disclosure.

The method may be implemented by enforcement rules definition module 100 of FIG. 1.

On step 500, enforcement rules definition module 100 may display a user interface to a user. The user interface may be graphical or textual. The user interface may enable the user to select a device, then select or define messages to be sent by the device, and add specific conditions to be validated, such as a target, a target-message type combination, or the like. In some embodiments, the user may enter free text or human readable documents which are parsed by a corresponding module of enforcement rules definition module 100 to obtain a rule definition or a basis for such a rule. The user can then continue editing the rule using a graphic user interface. In further embodiments, rules may be derived from files, for example, human readable files such as ICD format.

On step 504, the rule as described by the user may be received by enforcement rules definition module 100.

On step 508, computer code may be generated, for example by a corresponding wizard optionally incorporating some predetermined code, for intercepting a message and validating it against the defined rules. The computer code may be generated as binary code or as source code which can be further edited by a user. If required, the code can be compiled. The code can then be deployed on one or more devices within one or more networks.

It will be appreciated that the disclosure can be used in conjunction with additional protection measures, such as verifying each message by the receiving target device, activating anti-virus programs, or the like.

It will be also appreciated that in addition to the rules described above, referred to as “regular rules”, a black list of rules may also be defined for the whole system or for a specific transmitting device. Each rule in the black list may also be defined by conditions to be met by the values of fields in the message. If a message complies with a rule from the black list, it may be screened, even though it is in compliance with at least one regular rule. If contradiction exists such that a message complies with a regular rule, but also with one or more rules from the black list, the message may be transmitted or screened in accordance with a policy, and in either case a notification may be sent to a user.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product comprising a computer readable storage medium retaining program instructions, which program instructions when read by a processor, cause the processor to perform a method comprising:
intercepting a sequence of messages comprising at least one outgoing message of a first type transmitted by a first appliance within a network, the at least one outgoing message being directed to a second appliance, wherein the second appliance is allowed to receive messages of the first type in accordance with a collection of enforcement rules, wherein the at least one outgoing message comprising at least one field having a value, wherein the collection of enforcement rules is associated with the network;
validating the at least one outgoing message against the collection of enforcement rules; and
in response to the at least one outgoing message not complying with the collection of enforcement rules, screening the at least one outgoing message,
thereby protecting the second appliance from receiving the at least one outgoing message.

2. The computer program product of claim 1, wherein said validation comprises comparing the value of the at least one field to at least one value of a field of at least one enforcement rule of the collection of enforcement rules.

3. The computer program product of claim 1, wherein at least one rule of the collection of enforcement rules enables transmission of messages of the first type only in response to a source of the at least one outgoing message being included in a collection of predetermined sources, and wherein said validation comprises verifying that the first appliance is included in the collection of predetermined sources.

4. The computer program product of claim 1, wherein at least one rule of the collection of enforcement rules enables transmission of messages of the first type by the first appliance only within a predetermined time range, and wherein said validation comprises verifying that the at least one outgoing message is sent at a time within the predetermined time range.

5. The computer program product of claim 1, wherein at least one rule of the collection of enforcement rules enables transmission of messages of the first type by the first appliance only if the value is within a predetermined value range, and wherein said validation comprises verifying that the value is within the predetermined value range.

6. The computer program product of claim 1, wherein at least one rule of the collection of enforcement rules enables transmission of messages of the first type by the first appliance only when the second appliance is at a predetermined state, and wherein said validation comprises verifying that the second appliance is at the predetermined state at a transmission time of the at least one outgoing message.

7. The computer program product of claim 1, wherein at least one rule of the collection of enforcement rules enables transmission of messages of the first type by the first appliance only in response to a relative order kept between the at least one outgoing message and a second message, and wherein said validating comprises verifying that the relative order is kept between the at least one outgoing message and the second message transmitted.

8. The computer program product of claim 1, wherein said validating comprises checking whether a structure of the at least one outgoing message is in compliance with the collection of enforcement rules.

9. The computer program product of claim 1, wherein the processor further notifies a user responsive to the at least one outgoing message not complying with the rule.

10. A computer-implemented method, comprising:
intercepting a sequence of messages comprising at least one outgoing message of a first type transmitted by a first appliance within a network, the at least one outgoing message being directed to a second appliance, wherein the second appliance is allowed to receive messages of the first type in accordance with a collection of enforcement rules, wherein the at least one outgoing message comprising at least one field having a value, wherein the collection of enforcement rules is associated with the network;
validating the at least one outgoing message against a collection of enforcement rules, said validating comprising relating to the value; and
in response to the at least one outgoing message not complying with the collection of enforcement rules, screening the at least one outgoing message,
thereby protecting the second appliance from receiving the at least one outgoing message.

11. A computerized apparatus having a processor and network communication capabilities, the processor being adapted to perform the steps of:
intercepting a sequence of messages comprising at least one outgoing message of a first type transmitted by a first appliance, the at least one outgoing message being directed to a second appliance, wherein the second appliance is allowed to receive messages of the first type in accordance with a collection of enforcement rules, wherein the at least one outgoing message comprising at least one field having a value, wherein the collection of enforcement rules is associated with the network;
validating the at least one outgoing message against a collection of enforcement rules; and
in response to the at least one outgoing message not complying with the collection of enforcement rules, screening the at least one outgoing message,
thereby protecting the second appliance from receiving the at least one outgoing message.

12. The computerized apparatus of claim 11, wherein the computerized apparatus is implemented within the first appliance.

13. The computerized apparatus of claim 11, wherein the computerized apparatus is implemented within the network between the first appliance and any other network device.

14. The computerized apparatus of claim 11, wherein the steps are implemented as software instructions executed by the first appliance.

15. A computer program product comprising a computer readable storage medium retaining program instructions, which program instructions when read by a processor, cause the processor to perform a method comprising:
display and activate a user interface, with which a user can define at least one enforcement rule, the enforcement rule comprising allowed rule fields and rule values for outgoing messages to be transmitted by a first appliance;
receiving from the user a definition of the at least one enforcement rule; and
generating computer code for:
intercepting a sequence of messages comprising at least one outgoing message of a first type transmitted by a first appliance within a network, the at least one outgoing message being directed to a second appliance, wherein the second appliance is allowed to receive messages of the first type in accordance with a collection comprising the at least one enforcement rule, the at least one outgoing message comprising at least one field having a value;
validating the at least one outgoing message against the collection comprising the at least one enforcement rules, said validating comprising relating to the value; and
in response to the at least one outgoing message not complying with the collection of enforcement rules, screening the at least one outgoing message.
